(19) United States
(12) Patent Application Publication
(10) Pub. No.: US 2008/0255760 A1
(43) Pub. Date: Oct. 16, 2008

(54) Forecasting system

(75) Inventors: Jiri Rojicek, Prague (CZ); Karel Marik, Revnice (CZ)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/787,324

(22) Filed: Apr. 16, 2007

(51) Int. Cl. G06F 19/00

(52) U.S. Cl. 702/3; 702/4; 703/6

(57) ABSTRACT

A process includes providing a plurality of forecasts from a plurality of forecasting models. The plurality of forecasts each includes a mean and a variance. A model weight is calculated for each forecasting model. The model weight is proportional to the ability of that model to successfully forecast a queried situation. The plurality of forecasts are combined using an aggregate mean and an aggregate variance of the plurality of forecasts.

### TECHNICAL FIELD

Various embodiments relate to forecasting systems, and in an embodiment, but not by way of limitation, to a forecasting system involving multiple forecasts for each point to be predicted and forecast combinations for achieving better forecast quality.

### BACKGROUND

Forecasting models are ubiquitous throughout many industries including the chemical, utility, and automotive industries. In the utility industry, the demand for power can be forecasted. In the chemical and automotive industries, unit operation modeling can be used to determine the appropriate output of a particular plant. In these industries, the goal is to optimize the production of a product or provision of a service. In some instances, multiple forecasts from multiple sources (e.g., multiple homogeneous models, multiple heterogeneous models, and multiple domain experts) are used to obtain more robust and more reliable forecasts. It is at times however a problem to interpret such multiple forecasts.

### BRIEF DESCRIPTION OF THE DRAWINGS

FIG. 1 illustrates a flowchart of an example embodiment of a process to combine a plurality of forecasts.

FIG. 2 illustrates a flowchart of another example embodiment of a process to combine a plurality of forecasts.

FIG. 3 illustrates a flowchart of an example embodiment of a model tuning algorithm.

FIG. 4A illustrates a table of historical data including influencing factors and a real load (for example of a power plant).

FIG. 4B illustrates a table of past forecasts of three forecasting models.

FIG. 4C illustrates a table of squared Euclidean distances and weights/similarities.

FIG. 4D illustrates a table of weighted model errors.

FIG. 4E illustrates tables of a query, a mean and variance of the three forecast models of FIG. 4B, an aggregate forecast means and variance, a bandwidth, a growth ratio, and a sum of the weights, expected model errors, and normalized model weights for all of the forecasting models F1, F2, and F3 of FIG. 4B.

FIG. 5 illustrates a block diagram of an example embodiment of a computer system upon which one or more embodiments of the present disclosure may operate.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include digital/analog signal processing systems, software, data processing hardware, data processing system-implemented methods, and various processing operations, further described herein.

A number of figures show block diagrams of systems and apparatus of embodiments of the invention. A number of figures show flow diagrams illustrating systems and apparatus for such embodiments. The operations of the flow diagrams will be described with references to the systems/apparatuses shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

In one or more embodiments, a system and method combine multiple forecasts of individual forecasting models. Such a combination can lead to more accurate and robust estimations. An estimation of a model's ability to forecast a particular situation may be based on that model's forecast accuracy in past similar situations. The resultant forecast of the multiple models forecasting system may be evaluated as a weighted sum of other individual model forecasts.

In another embodiment, the system and method generate forecasting from multiple models, including an estimation of forecasting weight to be assigned to each of the individual models. The system then tunes the models in the system. In one embodiment, the system evaluates the performance of individual models for a given set of data, and then the system tunes individual models to support a specialization of the models for a specific situation. The resultant models may be treated as specialized forecast experts for the particular situation that occurred in the system and that generated this resultant model.

In another embodiment, the system and method invoke a computational schema and an archiving of forecasts. Such forecasts are usually computed using two types of input—a model of the system which can be based on either a system history (e.g., historical behavior of a system) or a different type of system model, and forecasts of influencing factors (e.g., factors forecasted by other means such as the weather). The computational schema generates computed results (i.e., forecasts) that allow the analysis of the changing accuracy of computed forecasts based on time and changing conditions (e.g., an improving forecast of influencing factors). The system can be applied to situations that involve forecasts that are computed for past events, which can simulate and test forecasting methods used on past data.

In an embodiment, a forecasting system combines multiple forecasts from multiple forecasting models to arrive at a resultant forecast. For example, a number of k different forecasts [m₁, v₁], [m₂, v₂], . . . [mₖ, vₖ] of k forecasting models F₁, F₂, . . . Fₖ, wherein mᵢ denotes a forecast mean and vᵢ a forecast variance of a model Fᵢ, can be combined. Using the means and variances of the different forecasting models, an aggregate mean M and an aggregate variance V of the resulting forecasted combination can be defined as follows:

$$M = {\sum }_{i = 0}^{k} {w}_{i} \cdot {m}_{i}$$

$$V = {\sum }_{i = 0}^{k} {w}_{i} \cdot ( {v}_{i} + {m}_{i}^{2} ) - {M}^{2}$$

The term wᵢ represents the model weights w₁, w₂, . . . wₖ that are to be applied in the calculation of the aggregate mean and variance as outlined above. The model weight wᵢ should be proportional to the ability of a model Fᵢ to successfully forecast a particular queried situation. The weights should sum to one. Other statistical measures besides a mean and a variance could also be used.

In an embodiment, the calculation and assignment of model weights are as follows. A goal is to estimate a model's ability to forecast a particular queried situation. First, a database is searched to locate process histories for situations that are similar to the queried situation. Second, past forecasts are found for all of the models that were located in the search of the database for the process histories that are similar to the queried situation. Third, the weight of each model is determined as a function of the model's accuracy in similar situations.

The search of the database to locate process histories for similar situations may be implemented as follows. For each particular situation defined by a query point (influencing factors usually known as a result of a separate prediction such as a meteorological forecast, a production plan, or operator-defined “what if” values), a forecasting engine retrieves data points from a historical dataset. These data points have values of influence variables that are similar to given (or query) variables. In this manner, only past situations that are similar to the present situation that is being queried are retrieved. For example, an evaluation of a Euclidean distance between the queried situation and all historical records can be performed. Then, the Euclidean distance may be transformed into a weight. In determining the weight of each model, wherein the weight is proportional to the model's accuracy in similar situations, the weight of a particular model is determined by aggregating forecast accuracy of a considered model in all past similar situations, while at the same time taking into account the similarity of the past situation to the queried situation. This may be done as follows. An average (i.e., weighted) absolute model error in a similar situation is evaluated. A kernel weighting function can then be applied, which generates a model weight. Examples of such kernel weighting that could be used are a Gaussian kernel and an Epanechnikov kernel. Thereafter, the resulting weights could be normalized so that the weights sum to one. These steps result in a set of historical records wherein each historical record has a weight that is proportional to its similarity to the queried situation. The use of a Euclidean distance is only one way that the similarity of situations may be evaluated. This evaluation could be done with other similarity measures as well.

A bandwidth considers a maximum distance in both directions along an axis in the multidimensional Euclidean space. Each bandwidth is associated with a particular influencing variable. The bandwidths form a neighborhood of a point where the system searches similar historical situations.

A growth rate parameter can be applied when an insufficient number of similar situations are retrieved from the historical database. The growth ratio defines the growth of the bandwidth parameter in case the algorithm has not found a sufficient number of similar historical points.

The location of the past forecasts for all of the models that have similar process histories to the queried situation is rather straightforward. The past forecasts are searched according to a timestamp associated with the past forecast. Alternatively, other identifiers or unique keys associated with the queried situations could be used. In situations that involve a variable forecast horizon, it is beneficial to include this information into the forecast search. For example, if the queried situation is a three day ahead forecast, then it is beneficial to search for the process histories of three day ahead forecasts.

After the foregoing processing, the system tunes the forecast consisting of the multiple models. This tuning of the forecast is most beneficial when the different models are significantly different from one another and when each model treats a reasonable percentage of the data correctly. In a favorable situation, the various models will complement each other, each model serving as a sort of specialist in a part of the domain where other models don't perform as well.

Therefore, once the forecasting system is able to recognize the domains in which each particular model is an expert, the forecasting models can be tuned to be experts in the identified domain or area. The model tuning can be implemented through an iterative execution of the following two steps. First, the models weights are evaluated and re-evaluated for all training inquiries. Such evaluations and re-evaluations may include forecasting training inquires by models as described above. As a byproduct of the forecasting, model weights are assigned to all training inquires. Second, each individual model is then tuned so that the best performance is achieved for queries with the high model weights. All models may be tuned sequentially. The optimization criteria reflects weights of testing queries computed in the first step. The tuning process is stopped either when the overall prediction accuracy of the forecasting system is not improved from one iteration to the next, or after a particular number of iterations.

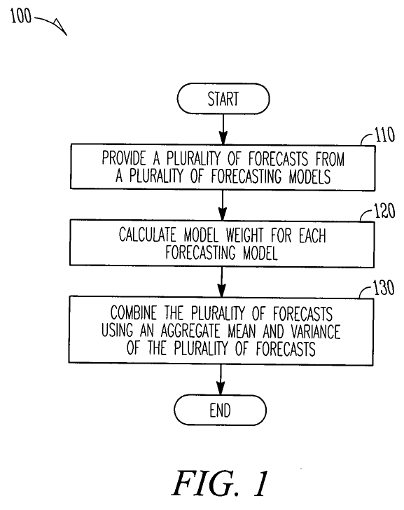

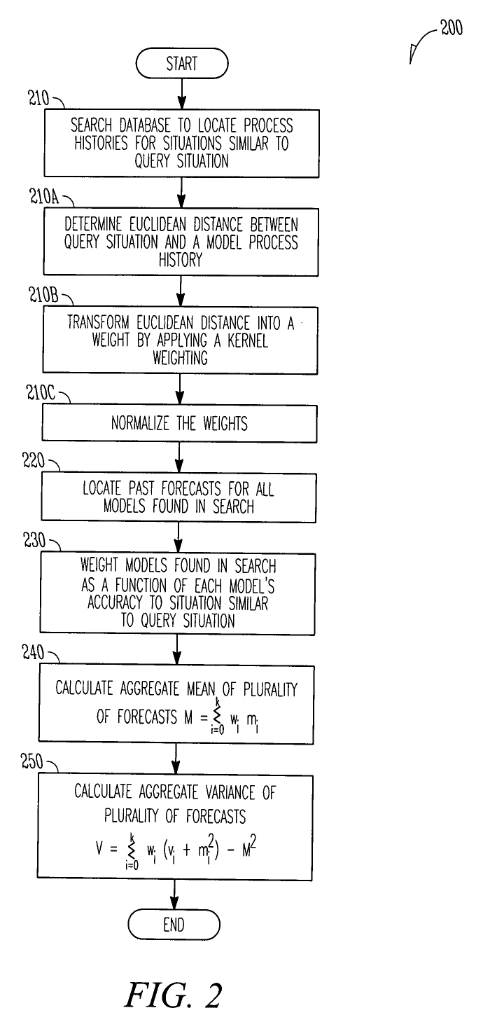

FIGS. 1 and 2 are flowcharts that illustrate an embodiment of the forecast combination as described above. Referring to FIG. 1, a process 100 includes providing a plurality of forecasts from a plurality of forecasting models at 110. The plurality of forecasts each include a mean and a variance. At 120, a model weight is calculated for each forecasting model. The model weight is proportional to the ability of that model to successfully forecast a queried situation. At 130, the plurality of forecasts are combined using an aggregate mean and an aggregate variance of the plurality of forecasts.

FIG. 2 illustrates additional details 200 of the process 100 or additional steps that could be used in connection with the process 100. Steps 210, 220, and 230 illustrate example steps that can be used to calculate the model weight. At step 210, a database is searched to locate process histories of models for one or more situations that are similar to the queried situation. At 220, past forecasts (and models used for their computation) corresponding to situations found in step 210 are located. At 230, the models found in the search are weighted as a function of each model's accuracy in a situation similar to the queried situation. Based on this, at 240, the aggregate mean of the plurality of forecasts is calculated by the following:

$$M = {\sum }_{i = 0}^{k} {w}_{i} \cdot {m}_{i}$$

wherein wᵢ represents the model weight of each forecasting model. Similarly, at 250, the aggregate variance of the plurality of forecasts is calculated by the following:

$$V = {\sum }_{i = 0}^{k} {w}_{i} \cdot ( {v}_{i} + {m}_{i}^{2} ) - {M}^{2}$$

wherein wᵢ represents the model weight of each forecasting model and vᵢ represents a variance of each forecasting model. As further indicated in FIG. 2, the search of the database can involve determining a Euclidean distance between the queried situation and a model process history at 210A, transforming the Euclidean distance into a weight by applying a kernel weighting at 210B, and normalizing the weights at 210C.

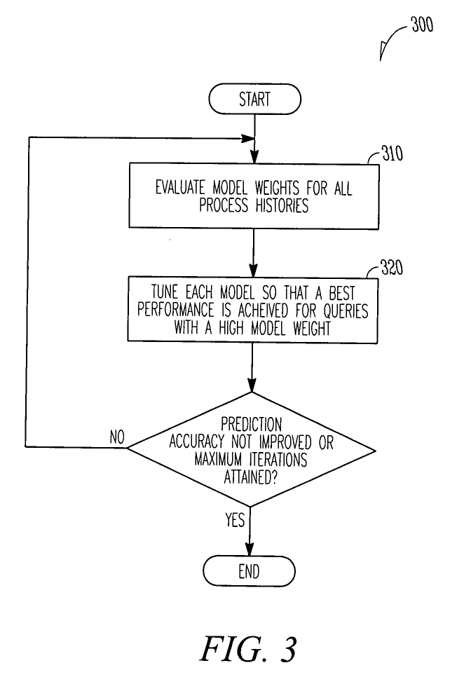

FIG. 3 illustrates a model tuning algorithm 300. The steps of FIG. 3 represent a tuning of multiple models that is independent of the forecasting algorithm 200 of FIG. 2. At 310 and 320, the forecasting system is tuned by evaluating the model weights for all the process histories located in the search of the database, and tuning each model so that a best performance is achieved for queries with a high model weight. As FIG. 3 illustrates, the tuning algorithm 300 is iterative, so that after step 320 a new iteration begins at step 310. As noted above, the tuning process may be halted either when the overall prediction accuracy of the forecasting system is not improved from one iteration to the next, or after a particular number of iterations.

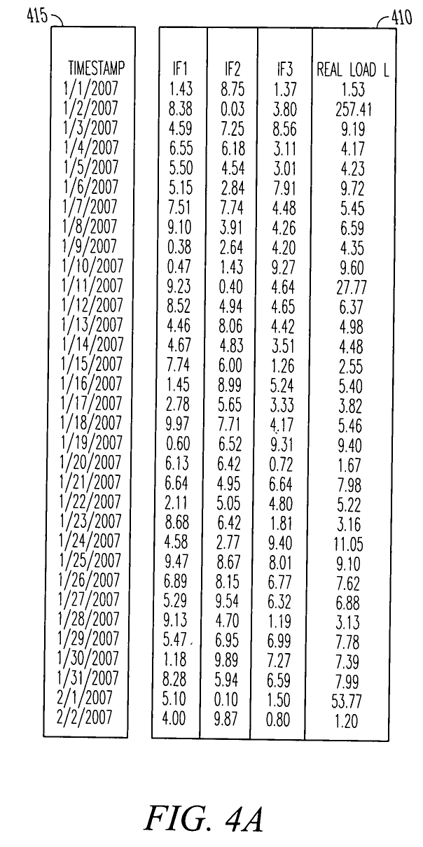

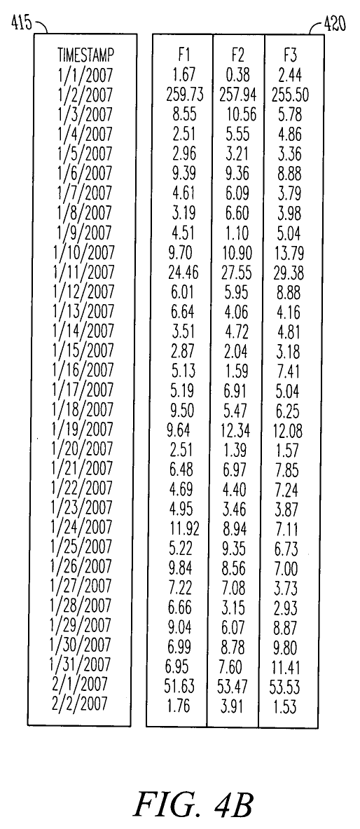

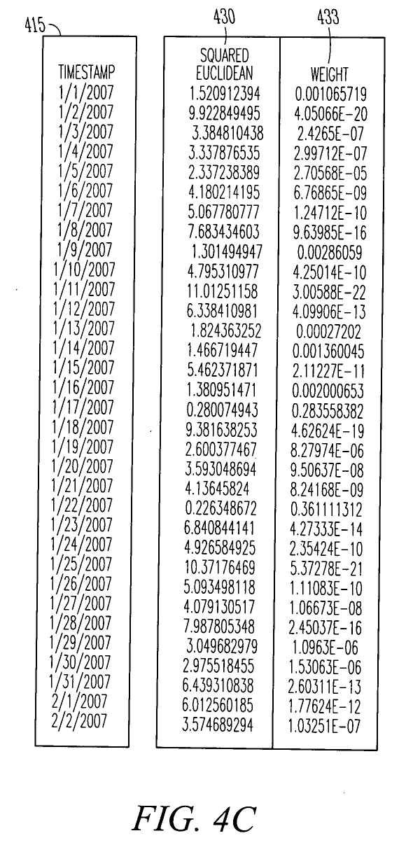

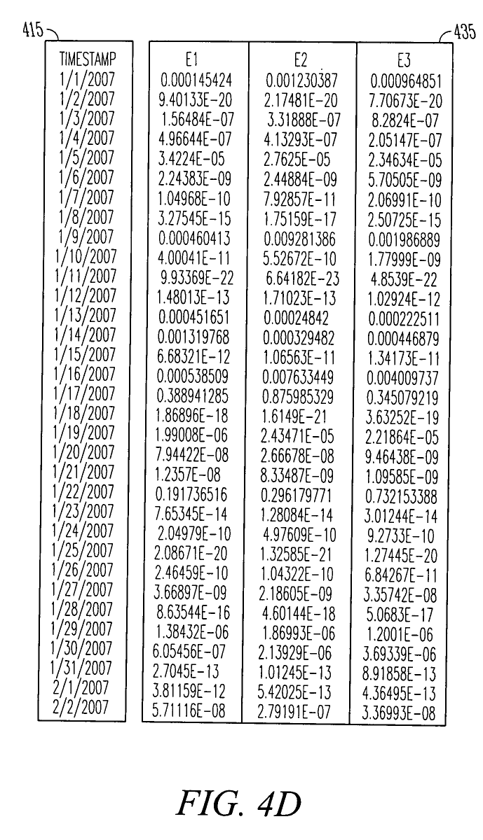

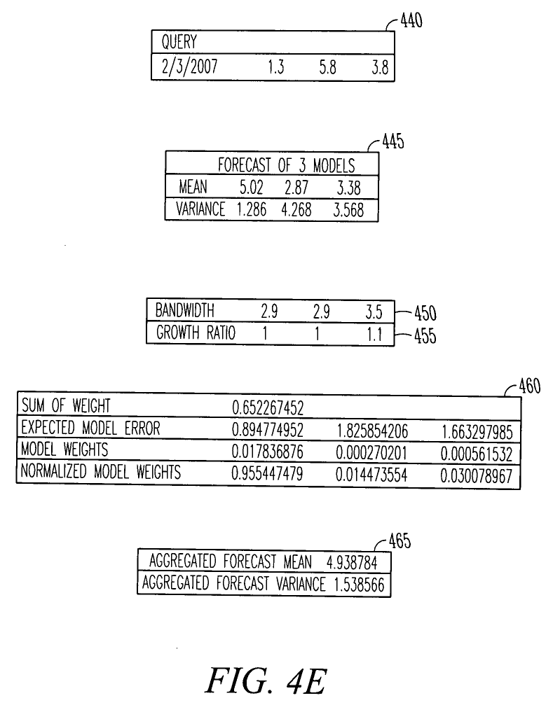

FIGS. 4A through 4E illustrate an example output of the just described system when used to combine forecasts for the load of a utility plant. FIG. 4A illustrates a table 410 of historical data of influencing factors IF1, IF2, and IF3, and a forecasted variable which in this example is the load L associated with each particular set of influencing factors. Each set of influencing factors and associated load is identified by a timestamp 415. The influencing factors for this example relate to such things as temperature and humidity. The load L is the demand for the power that is generated by the utility plant. FIG. 4B is a table 420 of the past forecasts of three forecasting models F1, F2, and F3. Virtually any forecasting model could be used to generate either of these forecasts F1, F2, and F3. Referring now to FIG. 4E, a query 440 is provided, such that the query is what will the forecasted load be if the influencing factors IF1, IF2, and IF3 are equal to 1.3, 5.8, and 3.8 respectively. Then, using the three forecasting models F1, F2, and F3 that were used to generate the forecasts in table 420 of FIG. 4B, three different forecasts are calculated for this query 440. These are reported as a mean and variance in table 445. At this point, situations similar to the query point are selected as described above. In an example, a bandwidth 450 and a growth rate 455 could be used. Then, as also described above, and as illustrated in FIG. 4C, a squared Euclidean distance 430 between the query and a historical measurement and a weight 433 are calculated as detailed above. Referring to FIG. 4D, weighted model errors 435 are computed for each model based on the model's prediction and the real load. Thereafter, as indicated in 460, the sum of the weights, expected model errors, and normalized model weights are computed for all of the forecasting models F1, F2, and F3. Finally, the aggregate (i.e., best) forecast mean and variance are calculated and reported at 465. This is the combined forecast result.

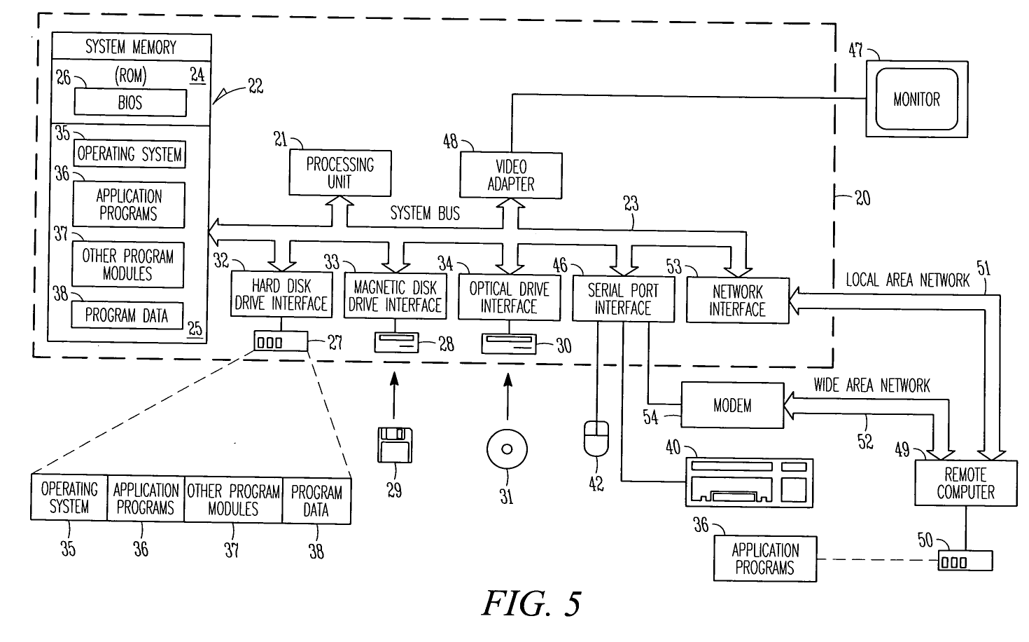

In the embodiment shown in FIG. 5, a hardware and operating environment is provided upon which one or more embodiments of the present disclosure may operate.

As shown in FIG. 5, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine can be resident on any one or number of these computer-readable media.

A user may enter commands and information into computer 20 through input devices such as a keyboard 40 and pointing device 42. Other input devices (not shown) can include a microphone, joystick, game pad, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the examples in the disclosure are not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 5 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the Internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

In the foregoing detailed description, various features are grouped together in one or more examples or examples for the purpose of streamlining the disclosure. This method of disclosure is not to be interpreted as reflecting an intention that the claimed examples of the invention require more features than are expressly recited in each claim. Rather, as the following claims reflect, inventive subject matter lies in less than all features of a single disclosed example. Thus the following claims are hereby incorporated into the detailed description as examples of the invention, with each claim standing on its own as a separate example. It is understood that the above description is intended to be illustrative, and not restrictive. It is intended to cover all alternatives, modifications and equivalents as may be included within the scope of the invention as defined in the appended claims. Many other examples will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A utility forecasting system comprising:
a module that provides one or more utility forecasts from one or more utility forecasting models, the one or more utility forecasts each comprising a statistical measure;
a module that calculates a model weight for each utility forecasting model, the model weight being proportional to the ability of that model to successfully forecast a queried situation; and
a module that combines the one or more utility forecasts using an aggregate statistical measure of the one or more utility forecasts;
wherein inputs to the utility forecasts include one or more of a meteorological forecast, a production plan, or operator-defined values.

2. The system of claim 1, wherein the statistical measure comprises a mean and a variance, and the aggregate statistical measure comprises an aggregate mean and an aggregate variance.

3. The system of claim 2, wherein the aggregate mean of the plurality of forecasts comprises
$$M = {\sum }_{i = 0}^{k} {w}_{i} \cdot {m}_{i}$$
wherein mᵢ, represents a mean for each utility forecasting model; and
wherein wᵢ, represents the model weight of each utility forecasting mode; and.
wherein the aggregate variance of the one or more utility forecasts comprises:
$$V = {\sum }_{i = 0}^{k} {w}_{i} \cdot ( {v}_{i} + {m}_{i}^{2} ) - {M}^{2}$$
wherein wᵢ represents the model weight of each utility forecasting model; and
wherein vᵢ represents a variance of each utility forecasting model.

4. The system of claim 1, wherein the module that calculates the model weight comprises:
a module that searches a database to locate process histories of models for one or more situations that are similar to the queried situation;
a module that locates past utility forecasts for all the models found in the search; and
a module that weights the models found in the search as a function of each model's accuracy in a situation similar to the queried situation.

5. The system of claim 4, wherein the module that searches a database comprises:
a module that determines a Euclidean distance between the queried situation and a model process history;
a module that transforms the Euclidean distance into a weight by applying a kernel weighting; and
a module that normalizes the weights.

6. The system of claim 5, wherein the kernel weighting comprises at least one of a Guassian kernel and an Epanechnikov kernel.

7. The system of claim 4, further comprising a module that tunes the utility forecasting system by:
evaluating the model weights for all the process histories located in the search of the database;
tuning each model so that a best performance is achieved for queries with a high model weight.

8. A process of utility forecasting comprising:
providing one or more utility forecasts from one or more utility forecasting models, the one or more utility forecasts each comprising a statistical measure;
calculating a model weight for each utility forecasting model, the model weight being proportional to the ability of that model to successfully forecast a queried situation; and
combining the one or more utility forecasts using an aggregate statistical measure of the one or more forecasts;
wherein inputs to the utility forecasts include one or more of a meteorological forecast, a production plan, or operator-defined values.

9. The process of claim 8, wherein the statistical measure comprises a mean and a variance, and the aggregate statistical measure comprises an aggregate mean and an aggregate variance.

10. The process of claim 9, wherein the aggregate mean of the plurality of forecasts comprises
$$M = {\sum }_{i = 0}^{k} {w}_{i} \cdot {m}_{i}$$
wherein mᵢ represents a mean for each utility forecasting model; and
wherein wᵢ, represents the model weight of each utility forecasting model; and
wherein the aggregate variance of the one or more utility forecasts comprises:
$$V = {\sum }_{i = 0}^{k} {w}_{i} \cdot ( {v}_{i} + {m}_{i}^{2} ) - {M}^{2}$$
wherein wᵢ, represents the model weight of each utility forecasting model; and
wherein vᵢ, represents a variance of each utility forecasting model.

11. The process of claim 8, wherein the calculation of the model weight comprises:
searching a database to locate process histories of models for one or more situations that are similar to the queried situation;
locating past utility forecasts for all the models found in the search; and
weighting the models found in the search as a function of each model's accuracy in a situation similar to the queried situation.

12. The process of claim 11, wherein the searching a database comprises:
determining a Euclidean distance between the queried situation and a model process history;
transforming the Euclidean distance into a weight by applying a kernel weighting; and
normalizing the weights.

13. The process of claim 12, wherein the kernel weighting comprises at least one of a Guassian kernel and an Epanechnikov kernel.

14. The process of claim 11, further comprising tuning the utility forecasting system by:
evaluating the model weights for all the process histories located in the search of the database;
tuning each model so that a best performance is achieved for queries with a high model weight.

15. The process of claim 8, wherein the calculating a model weight comprises:
evaluating the similarity of past situations for a model to the queried situation; and
aggregating forecast accuracy of a model in all past situations that are similar to the queried situation.

16. A machine readable medium including instructions for executing a process comprising:
providing one or more utility forecasts from one or more utility forecasting models, the one or more utility forecasts each comprising a statistical measure;
calculating a model weight for each utility forecasting model, the model weight being proportional to the ability of that model to successfully forecast a queried situation; and
combining the one or more utility forecasts using an aggregate statistical measure of the one or more utility forecasts;
wherein inputs to the utility forecasts include one or more of a meteorological forecast, a production plan, or operator-defined values.

17. The machine readable medium of claim 16, wherein the statistical measure comprises a mean and a variance, and the aggregate statistical measure comprises an aggregate mean and an aggregate variance.

18. The machine readable medium of claim 17, wherein the aggregate mean of the plurality of forecasts comprises
$$M = {\sum }_{i = 0}^{k} {w}_{i} \cdot {m}_{i}$$
wherein mᵢ, represents a mean for each utility forecasting model; and
wherein wᵢ, represents the model weight of each utility forecasting model; and
wherein the aggregate variance of the one or more utility forecasts comprises:
$$V = {\sum }_{i = 0}^{k} {w}_{i} \cdot ( {v}_{i} + {m}_{i}^{2} ) - {M}^{2}$$
wherein wᵢ represents the model weight of each utility forecasting model; and
wherein vᵢ represents a variance of each utility forecasting model.

19. The machine readable medium of claim 16, further comprising instructions for:
searching a database to locate process histories of models for one or more situations that are similar to the queried situation;
locating past utility forecasts for all the models found in the search; and
weighting the models found in the search as a function of each model's accuracy in a situation similar to the queried situation.

20. The machine readable medium of claim 19, wherein the instructions for searching a database comprises:
determining a Euclidean distance between the queried situation and a model process history;
transforming the Euclidean distance into a weight by applying a kernel weighting; and
normalizing the weights.
